(19) United States
(12) Patent Application Publication
(10) Pub. No.: US 2008/0245359 A1
(43) Pub. Date: Oct. 9, 2008

(54) Tunnel Oven

(75) Inventor: Mark Williamson, Cambridge (GB)

Correspondence Address: QUARLES & BRADY LLP, ONE SOUTH CHURCH AVENUE, SUITE 1700, TUCSON, AZ, 85701-1621, US

(73) Assignee: FYLDE THERMAL ENGINEERING LIMITED, Cambridge (GB)

(21) Appl. No.: 12/065,428

(22) PCT Filed: Sep. 7, 2006
(86) PCT No.: PCT/GB06/03302

§ 371 Date: Feb. 29, 2008

(30) Foreign Application Priority Data
Sep. 7, 2005 (GB) 0518186.2
Sep. 7, 2006 (GB) PCT/GB2006/003302

(51) Int. Cl. A21B 1/48; A21B 1/40; A21B 2/00

(52) U.S. Cl. 126/39 C; 99/443 C; 126/39 D; 126/39 G; 126/15 A

(57) ABSTRACT

The present invention relates to a tunnel oven having a baking chamber 4 and a conveyor for carrying items to be baked through the baking chamber 4. The oven 2 comprises an in-direct fired radiant heat source 22, a forced-air radiant heat source 26, the radiant and convective heat source 22a, 26, wherein there is an adjustment means 72, 349, 36, 202, 204, 210 to independently change the atmospheric moisture content in the baking chamber and the quantities of radiant and convective heat, the convective heat being adjustable between 0% and 100% of maximum available forced-air supply into the baking chamber 4.

The present invention relates to tunnel ovens, which may be used for processing a wide variety of materials, including food.

In food applications, such as bread, biscuits, pies, pizzas, baked confectionary and snacks etc. the food is conveyed on a conveyor through a heat transfer or baking chamber on a continuous basis, with residence times that range from 30 seconds to 60 minutes or more. The baking chamber is typically 20 to 130 metres long and 1 to 4 meters wide. The oven is usually physically divided into heat transfer zones, each with its own operator settings. The conveyor is typically an endless belt, with the return path positioned underneath the baking chamber. The food may be carried directly on the conveyor, or in metal containers that are carried on the conveyor.

A heat source is usually provided above and below the belt. In most cases heat from below enters the food primarily by conduction, either via direct contact with the belt or through metal containers, if provided. The heat source above the belt transmits heat down on to the upper surfaces of the food items as they are conveyed through the oven, by a combination of condensation, radiation and convection. The fuel for both heat sources is usually natural gas (methane) or propane.

Flavour and colour attributes of baked foods, mainly resulting from Maillard-type reactions, can be significantly influenced by the temperature and moisture content profiles of the surfaces layers of the food during baking.

For the lower surfaces of most baked food items, these temperature and moisture profiles can be influenced in the oven by the temperature profile of the conveyer belt or metal container. This belt/container temperature profile may be achieved by any combination of radiation, convection, and condensation, without any other significant impact on the baked food attributes. However, for the upper exposed surfaces of the food the temperature/moisture profiles of the surface layers of the food can be dramatically affected by the balance of condensation, radiation and convection heat transfer experienced in the baking chamber.

Condensation heat transfer generally occurs only at the start of the baking process, when the surface temperature of the food may still be below the dew point of the baking chamber atmosphere. In many ovens the dew point is too low for any condensation to occur. Condensation on the surface of the food rapidly heats the food, but with a net gain of moisture, rather than a net loss of moisture that would accompany an equivalent quantity of radiation or convection heat transfer. It is therefore advantageous to be able to control accurately the moisture content of the baking chamber atmosphere, particularly at the start of the tunnel oven.

Throughout the entire length of the baking chamber, the ratio of radiation heat transfer to convention heat transfer will affect the temperature/moisture profiles of the top (exposed) surface layers of the food. Convection heat transfer (particularly forced convection) is known to remove moisture from the surface layers of food more quickly than an equivalent quantity of radiation heat transfer. In practise, other factors may also influence the selection of this heat transfer ratio. For example, the maximum quantity of forced convection heat transfer that can be used in a particular application may be limited by a requirement to avoid physical disturbance of the food pieces on the conveyor. For these reasons, it is advantageous to maximise the ranges of independent adjustability of radiation and convection heat transfer to the top surfaces of the food.

Ovens may be either direct-fired, in which case the products of combustion from the burning of the fuel enter the baking chamber, or they maybe indirect-fired, in which case these combustion gases do not enter the baking chamber. In most known baking ovens, the burner firing rate modulates in order to maintain a predetermined temperature set-point in the baking chamber. This modulation generates variable quantities of combustion gases (at circa 19% volume water vapour for combustion of methane). For direct-fired ovens the effect of this is sufficient to make it impossible to decouple control of heat input and control of atmospheric water vapour content. In practise, dew points in excess of 70° C. cannot be achieved in direct-fired ovens without injection of large quantities of superheated steam, which is normally not commercially viable. Hence in direct-fired ovens, condensation heat transfer cannot be consistently controlled, and cannot be sustained for the maximum possible time (i.e. until the food surface reaches 100° C.). This represents a significant disadvantage of direct-fired ovens.

A further disadvantage of known baking ovens (both direct and indirect fired) is their exhaust systems which often pull excessive quantities of relatively dry air into the oven from the atmosphere, primarily via the inlet and outlet openings to the baking chamber, further adding to the low humidity level, furthermore, additional gas must be burnt to heat up the ambient air drawn into the oven, which is then simply exhausted through the stacks. This represents a significant inefficiency in terms of fuel usage, and unnecessary generation of greenhouse gases.

A further disadvantage of known baking ovens (both direct and indirect fired) is the limited range of convection heat transfer rates that can be utilised. In a forced convection oven, hot air is supplied to plenum chambers that span the width of the baking chamber. Arrays of nozzles in these plenum chambers create air jets, which impinge on the food. In order to achieve an even distribution of airflow across the width of the baking chamber and along its length (to enable the food to be evenly cooked across the width of the conveyor) it is necessary to achieve a minimum back-pressure of the re-circulating air inside the plenum chambers. In order to avoid significant imbalances occurring at the lowest convection velocity settings, turn down must be limited to 40-50% of maximum airflow velocities, otherwise air is not driven through the all the outlet nozzles evenly.

A further disadvantage of known baking ovens is the limited quantity of radiation heat transfer available. In baking ovens, radiation intensity received by the food is approximately proportional to the fourth power of the temperature of the emitter. The temperature of the oven walls, ceiling, plenum chambers and baking chamber atmosphere is usually practically limited by materials of construction and the air circulation system to circa 450° C., at which temperature radiation emission levels are relatively low. Any sources of significant radiation must achieve temperatures in excess of 800° C., as found for example in flames and in ceramic/metallic surfaces that are glowing red hot. Such sources are normally positioned intermittently along the oven and therefore radiation heat transfer varies along the length of the oven, being at its most intense directly beneath a source, and dropping to much lower value midway between two sources. Any significant radiation tends to be highly localised, so that typically only 10 to 50% of a foods residence time in a baking chamber is effective in delivering significant radiation heat transfer.

A further disadvantage of known baking ovens is that burners used as localised radiation sources cannot be switched to provide forced convection heat transfer only. Hence an oven that provides independent adjustment of significant quantities of both radiation and forced convection heat transfer must incorporate duplicate burners—localised burners for radiation and usually a single, centralised burner per oven zone in the air recirculation system for forced convection.

It is an object of the present invention to provide a tunnel oven which overcomes or alleviates the above described disadvantages.

In accordance with a first aspect of the invention there is provided a tunnel oven having a baking chamber and a conveyor for carrying items to be baked through the baking chamber, an in-direct fired radiant heat source operable to supply radiant heat into the baking chamber, a forced-air convection heat source operable to selectively supply heat by forced-air convection into the baking chamber, an air-recirculation system which has means to draw air from the oven chamber and means to supply that air to the forced-air convection heat source, and adjustment means to independently change the atmospheric moisture content in the baking chamber and the quantities of radiant heat and convective heat, the convective heat being adjustable between 0% and 100% of maximum available forced-air supply into the baking chamber.

The oven may have a convection heat transfer to top surface of food in the range 10-140 W/m²° C. The value of 10 W/m²° C. represents maximum possible turndown to residual natural convection values (i.e. no forced convection) at the lowest processing temperatures typically used for commercial applications of circa 150° C. Existing convection ovens have turndown capabilities of circa 40-50% of maximum values.

Radiation heat transfer may be in range Tr=150-700° C. where Tr is the hemispherically averaged perceived radiation temperature, as experienced by the upper surfaces of food items travelling on the conveyor. The value of 150° C. represents the lowest baking chamber temperatures found in commercial ovens. The value of 700° C. represents an increase of 350° C. above the upper limit typically available in existing ovens, which equates to a potential increase in radiation energy transmission of nearly 600% compared to existing ovens.

The oven has the advantage that heat transfer mode to the top surface of the food is easily adjustable.

Humidity levels of 2% to 98% by volume water vapour are achievable in the baking chamber, and are controllable. The value of 2% is typical of ambient air at 50% RH. The value of 98% is equivalent to a wet bulb temperature of 99° C., as is essentially a superheated steam environment where nearly all air has been excluded. Existing direct fired ovens cannot economically achieve values higher than 40% (web bulb +76° C.).

The adjustment means may be adapted to adjust the distribution of at least one of radiant heat and convective heat supplied along the length of the conveyor to provide a substantially even heat profile along the length of the conveyor.

The radiant heat may be adjusted by selectively altering the amount of heat emitted across the profile of the radiant heat source, this may include progressively reducing the amount of heat emitted from radiant heat source the nearer a surface of the heat source is located towards the conveyor. The reduction in heat may be by providing means to reduce heat which may include emissivity coating and/or tuning means and/or a reduction in the amount of heat supplied by cooling. The distribution of radiant heat may be by the provision of reflectors. The convention heat supplied may be adjusted by maintaining a substantially constant static pressure in a plenum chamber which supplies said forced-air convention heat into the baking chamber to enable an even supply and may be by the provision of air outlets from the plenum into the baking chamber having a defined distribution and/or aperture sizes to enable a uniform convention heat flex along the length of the oven.

In accordance with a second aspect of the present invention there is provided a tunnel oven having a baking chamber and a conveyor for carrying items to be baked through the baking chamber, an in-direct fired radiant heat source operable to supply radiant heat into the baking chamber, a forced-air convection heat source operable to selectively supply heat by forced-air convection into the baking chamber, an air-recirculation system which has means to draw air from the oven chamber and means to supply that air to the forced-air convection heat source, and adjustment means to selectively change the ratio of radiant and convective heat supplied to the baking chamber, wherein the radiant heat source and convection heat source comprise a common heat source and the adjustment means is adapted to switch said common heat source between heating air supplied to said forced-air convection heat source and said radiant heat source.

The adjustment means may be adapted to partially switch said common heat source to heat said radiant heat source and said air for said forced-air convection heat source.

The radiant heat source may encapsulate the common heat source within a radiator tube located transverse to and extending across the conveyor, wherein a first face of the radiator tube faces the conveyor and a second face of the radiator tube faces the air recirculation system of the oven, the means to draw air from the oven chamber being conductively connected to the said second face of said radiator tube, and wherein the adjustment means comprises a moveable deflector to deflect the common heat source within the radiator tube and which is moveable between a position whereat said common heat source heats said first face of said radiator tube and a position whereat it heats said second face of said radiator tube. The common heat source may be a burner assembly, the burner assembly may have at least one ribbon burner having a plurality of outlet apertures along its length and which extend longitudinally within the tube and which is adapted to provide a ribbon of flames, the deflector being selectively moveable to direct said flames towards said first or second face of said tube. A reflector may be mounted about said first face to spread radiant heat across the conveyor.

The oven may comprise maintaining means to maintain a substantially constant pressure in the air recirculation system, the maintaining means may comprise means to selectively adjust the supply of forced-air into the baking chamber by redirecting that air back into the air-recirculation system.

The radiator tube may be closed at one end by an oven face plate provided in exterior surface of the oven, the burner assembly may be replaceable. The ribbon burner may be removably mounted in the burner assembly. The ribbon burner may comprise two diametrically opposed ribbon apertures aligned within the tube, with a gas/air supply chamber provided there between, wherein an ignition electrode is provided at one end of one said ribbon apertures and optionally a sensing electrode is provided at the same end of the other ribbon aperture, a bridging section is provided between the other ends of said ribbon apertures.

The radiator tube may comprise a combustion gas exhaust which feeds into a combustion gas collection duct which leads to an exhaust stack, a heat exchanger may be provided between the gas collection duct and the air-recirculation system. An exhaust of the air-recirculation system may lead into said gas collection duct, a vent control damper may be provided in said air-recirculation exhaust.

In a preferred embodiment the radiator tube comprises a main combustion tube which leads into a series of successive radiation mode tubes and a series of successive convection mode tubes, the radiation and convection mode tubes may be provided annularly about the main combustion tube and may respectively zig zag backward and forwards along the length of the main combustion tube and may lead from the outlet of the main combustion tube to the or a combustion gas exhaust. A burner may be provided to provide a flame along the main combustion tube. A diverter valve may be provided which valve is adjustable to alter the flow of combustion gas from the main combustion tube into the respective radiation and convection mode tubes.

In accordance with a third aspect of the present invention there is provided a tunnel oven having a baking chamber and a conveyor for carrying, items to be baked through the baking chamber, an in-directed fired radiant heat source operable to selectively supply radiant heat into the baking chamber, a forced-air convection heat source operable to selectively supply heat by forced-air convection into the baking chamber, and adjustment means to selectively change the ratio of radiant and convective heat supplied to the baking chamber by adjusting amount of forced-air supplied into the baking chamber, wherein the forced-air convection heat source comprises at least one plenum which supplies air to a plurality of air outlets which lead into the baking chamber, the adjustment means having a maintaining means to maintain a substantially constant static pressure in the plenum chamber.

The adjustment means may be adapted to adjust the forced-air convection heat source between 0% and 100% of maximum available forced-air supply into the baking chamber.

The adjustment means may comprise radiant heat adjustment means to adjust the amount of heat supplied by the radiant heat source. The adjustment means may be adapted to adjust the radiant heat source between less than 10% and 100% of the maximum available radiant heat supply into the baking chamber. The radiant heat source and forced-air convection heat source may comprise a common heat source, the adjustment means being adapted to switch said common heat source between heating said radiant heat source and heating air supplied to said forced-air convection heat source.

The oven may comprise an air-recirculation system which draws in air delivered by the plenum and re-supplies the air to the plenum. Oven air outlets may be provided in the baking chamber which lead into the air recirculation system. The oven air outlets may be conductively connected to the radiant heat source. The plenum may have a plurality of further air outlets which lead into the air-recirculation system, the maintaining means being adapted to switch the supply of forced-air between the air outlets and further air outlets in a balanced manner to maintain said static pressure in the plenum. The air outlets may have defined distribution and/or aperture size to provided a uniform convection heat flux along the length of the oven. The further air outlets may be conductively connected to the radiant heat source and may open into the oven air outlets. The maintaining means may comprise at least one baffle moveable across the air outlets and further air outlets. In a preferred embodiment the maintaining means comprises two such baffles.

The radiant heat source may comprise a plurality of radiant heaters each comprising a burner enclosed within a radiator tube. Each radiator tube may comprise a respective reflector facing the conveyor to spread radiation energy emitted from the radiator tube along the conveyor. Each reflector may comprise a pair of wings which extend along the length of the tube and from opposite sides of the radiator tube which may form a substantially v-shaped configuration open towards the conveyor. The profile of the wings may be configured to create a uniform intensity of radiation at the conveyor, both directly underneath and before/after each radiator tube in the direction of travel of the conveyor. The reflector wings may be removable. Each radiator tube may be located transverse to and extend across the conveyor, and being spaced apart in longitudinal direction of conveyor.

The radiator tubes may be provided both above and below the conveyor within the baking chamber.

A said plenum may be provided between adjacent respective pairs of radiator tubes. The oven outlet may be provided between the radiator tubes and their reflectors.

In accordance with a fourth aspect of the present invention there is provided a tunnel oven having a baking chamber and a conveyor for carrying items to be baked through the baking camber, an in-directed fired radiant heat source operable to selectively supply radiant heat into the baking chamber, a forced-air convection heat source operable to selectively supply heat by forced-air convection into the baking chamber, wherein the forced-air convection heat source comprises at least one plenum which supplies air to a plurality of air outlets which lead into the baking chamber, the air outlets having a specific distribution and/or aperture size to provide a uniform convective heat flux along the length of the oven.

In accordance with a fifth aspect of the present invention there is provided a tunnel oven having a baking chamber and a conveyor for carrying items to be baked through the baking chamber, radiant heat source operable to supply radiant heat into the baking chamber, wherein the radiant heat source comprise a radiation reflector facing the conveyor to spread radiation emitted from the radiant heat source along the conveyor.

In a preferred embodiment the oven chamber incorporates a plurality of zones at least one which has a descrete radiant heat source, a forced-air convection source, a recirculation system to draw air from oven chamber and to supply it to said forced-air convection system, and combustion gas exhaust.

The oven is capable of being reconfigured in less than 10 minutes, using adjustments accessible to the oven operator, and requiring no engineering tools.

Exhaust flow rates in the new oven are controlled to minimum practical values, minimum practical values being determined for a particular baking process by the humidity level required in the baking chamber. To this end sensor may be provided in the baking chamber to control exhaust from air recirculation system.

In a further preferred embodiment the items to be baked are food items.

In accordance with a sixth aspect of the present invention there is provided a tunnel oven having a baking chamber and a conveyor for carrying items to be baked through the baking chamber, an in-direct fired radiant heat source operable to supply radiant heat into the baking chamber, the radiant heat source having means to adjust the amount of heat emitted down on to the conveyor in order to provide an even heat distribution along the conveyor.

By way of example only specific embodiment of the inventor will now be described with reference to the accompanying drawings, in which:

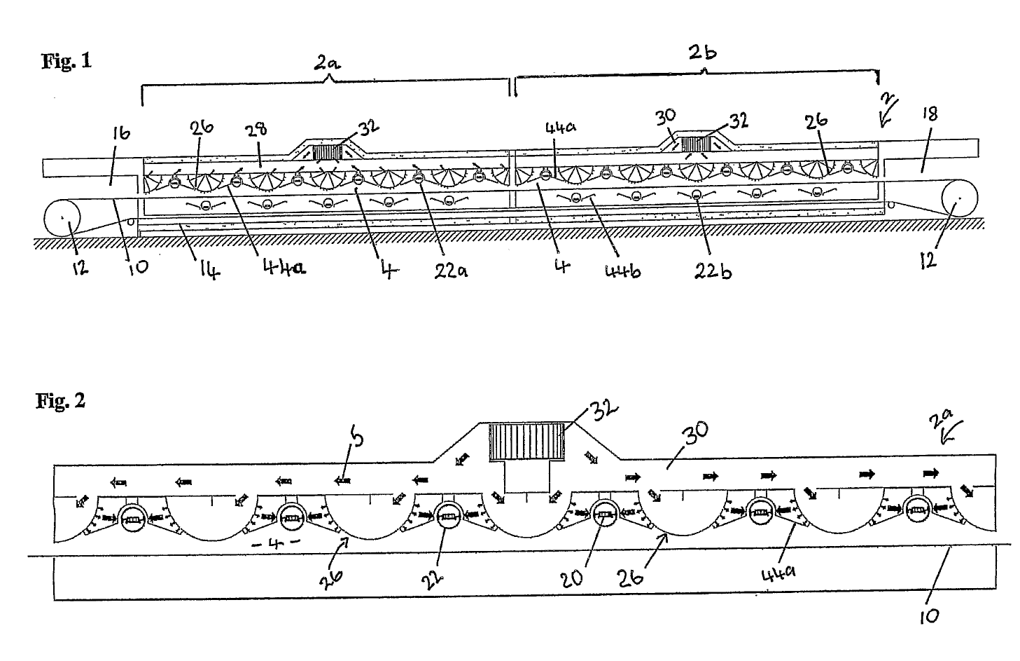

FIG. 1 is a schematic longitudinal sectional view of a 2-zone tunnel; oven constructed in accordance with the present invention;

FIG. 2 is a longitudinal sectional view of one of the zones of the oven illustrating the supply path of the air when the zone is operating in radiation mode, lower radiators omitted for ease of illustration;

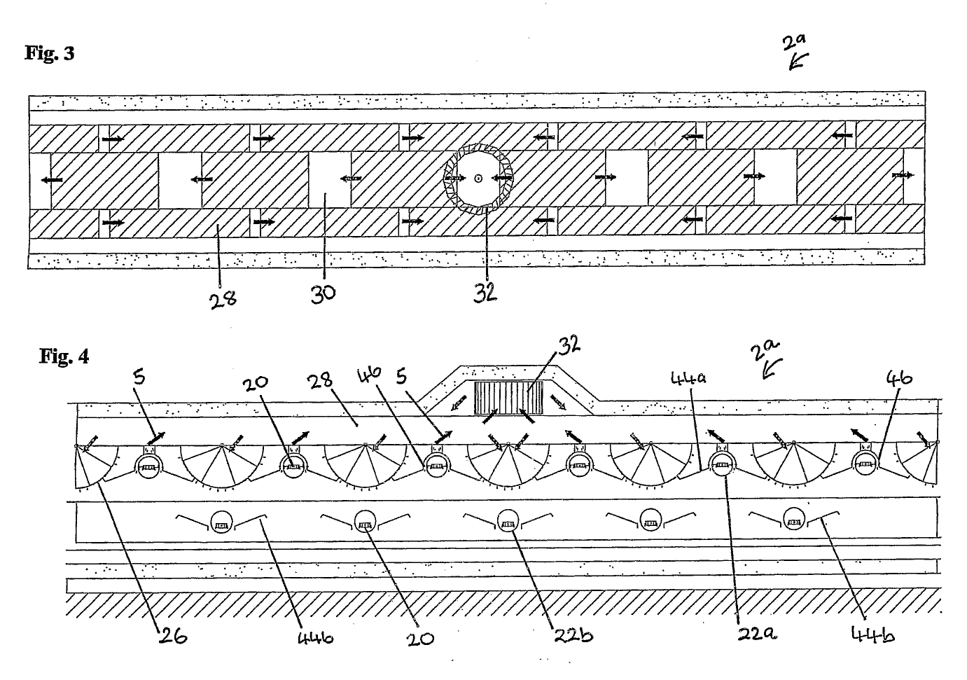

FIG. 3 is a plan sectional view of one of the zones showing the supply and return paths for the air;

FIG. 4 is an enlarged longitudinal sectional view of one of the zones illustrating the supply and return path of the forced convection to the plenum chambers, conveyor belt omitted for ease of illustration;

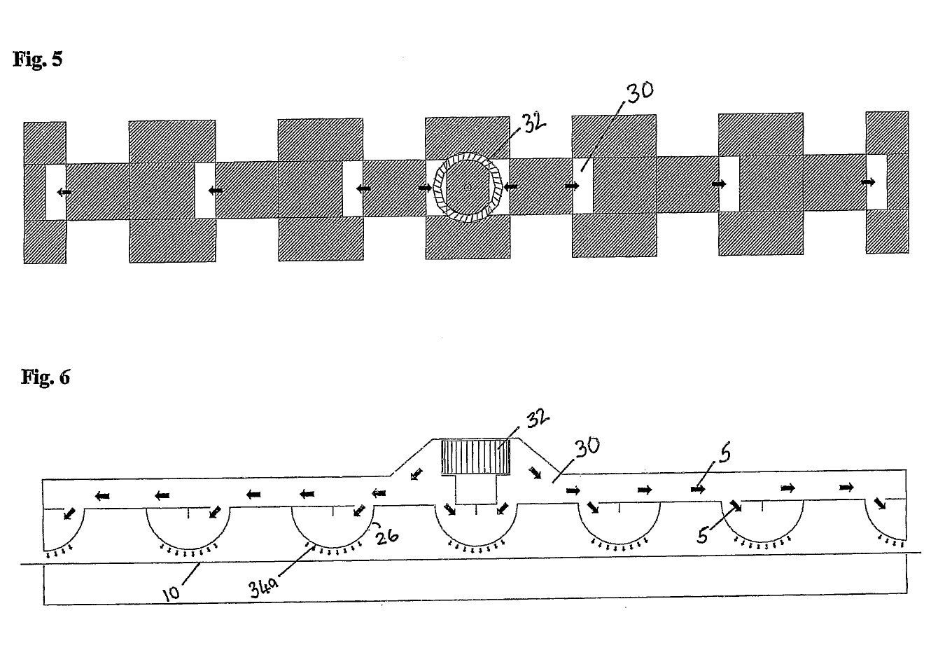

FIG. 5 is a plan view showing the air supply path of the air supply ducts to the plenum chambers;

FIG. 6 is a schematic longitudinal sectional view showing the supply of air to the plenum chambers, radiator tubes omitted for ease of illustration;

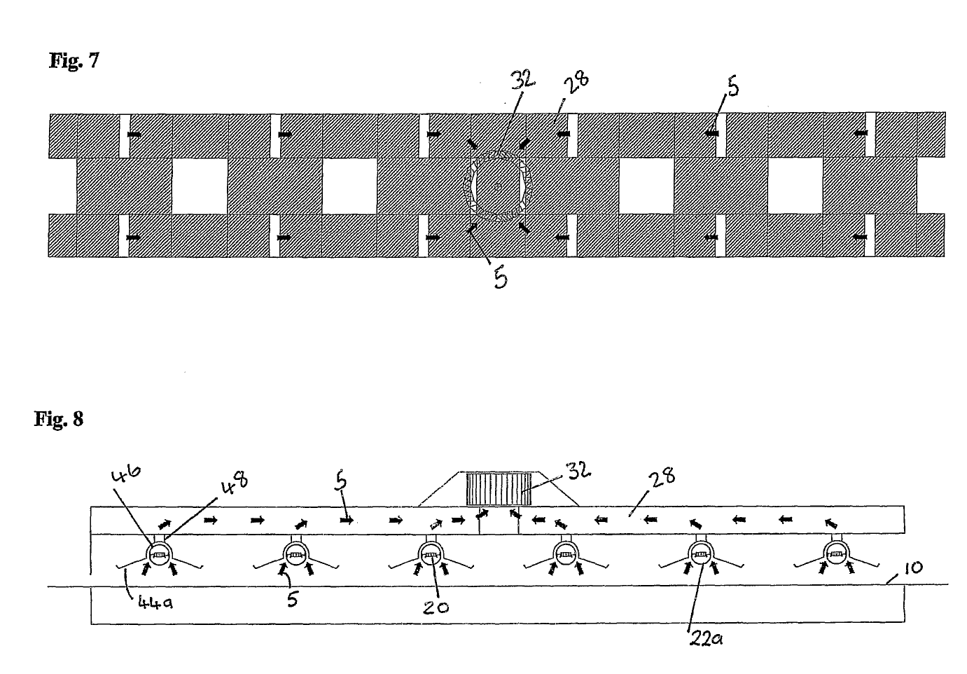

FIG. 7 is a plan view showing the air return path of the air return ducts;

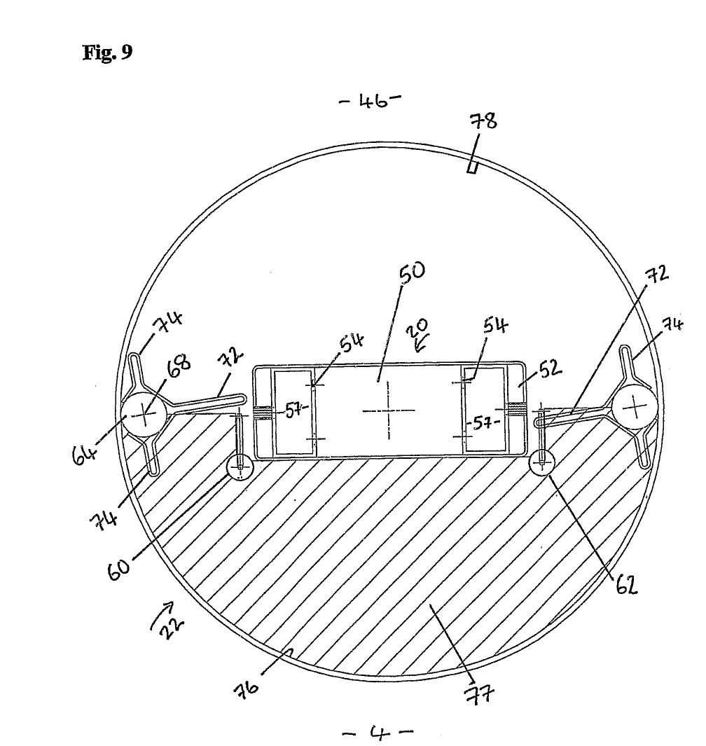

FIG. 8 is a schematic longitudinal section view showing the return of air via the upper radiator tubes air return channels and air return ducts, when the zone is in forced-air convection mode, plenum chambers omitted for ease of illustration;

FIG. 9 is a cross-section view of a radiator tube, illustrating the left hand side of the tube in radiation mode and the right hand side of the tube in convection mode;

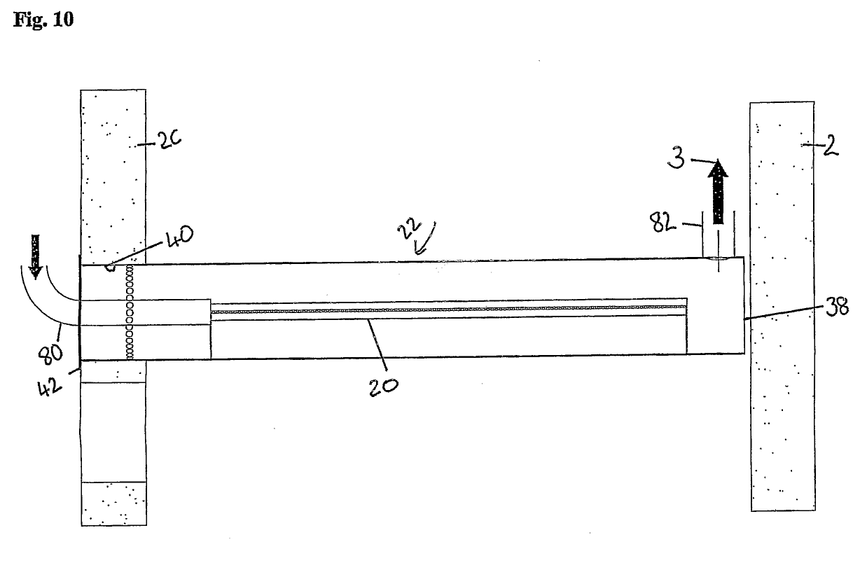

FIG. 10 is a longitudinal sectional view of a radiator tube;

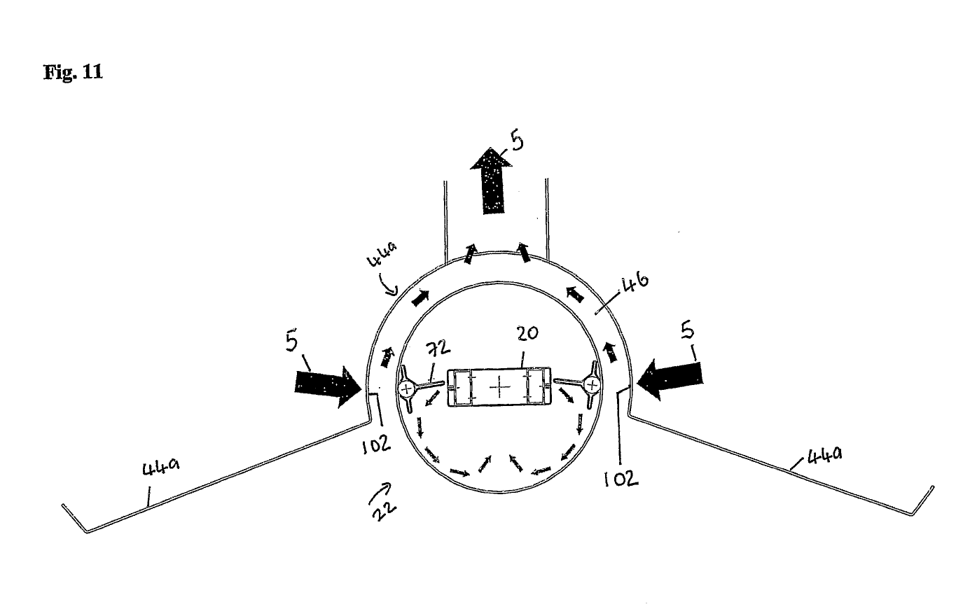

FIG. 11 is a cross sectional view of an upper radiator tube and upper reflector, illustrating the radiator in radiation mode;

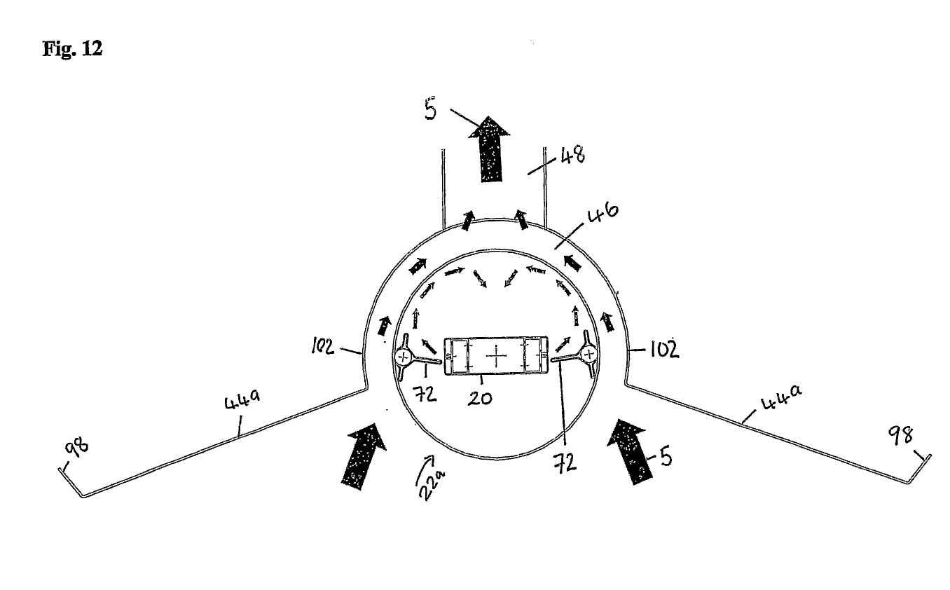

FIG. 12 is a view similar to FIG. 11, showing the radiator heating the returning air when the zone is in forced-air convection mode;

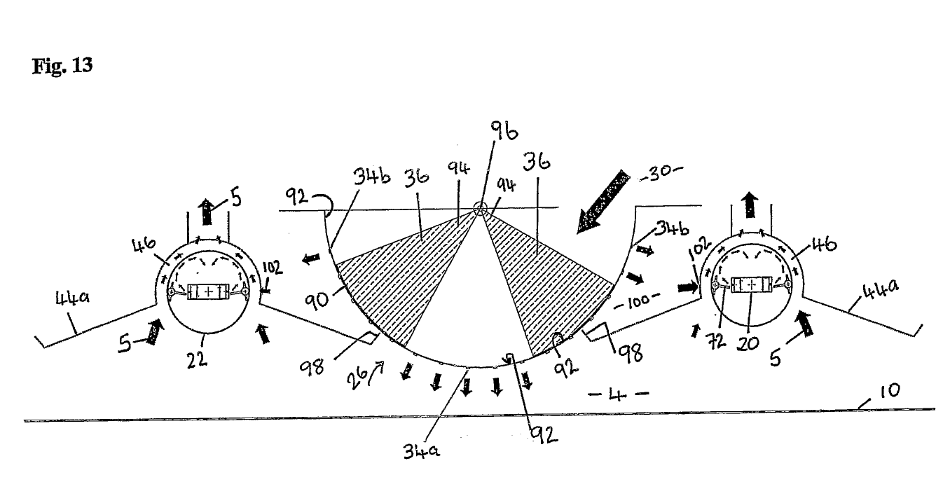

FIG. 13 is a cross-sectional view though two upper radiator tubes and a plenum chamber, with some forced-air convection (75% of maximum for left side of plenum, 50% of maximum for right side of plenum);

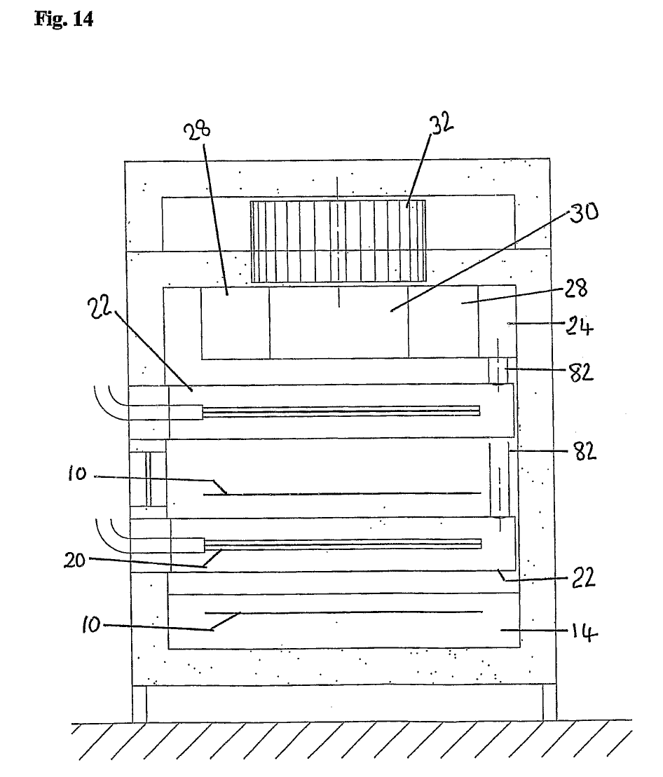

FIG. 14 is a schematic cross sectional view through the oven;

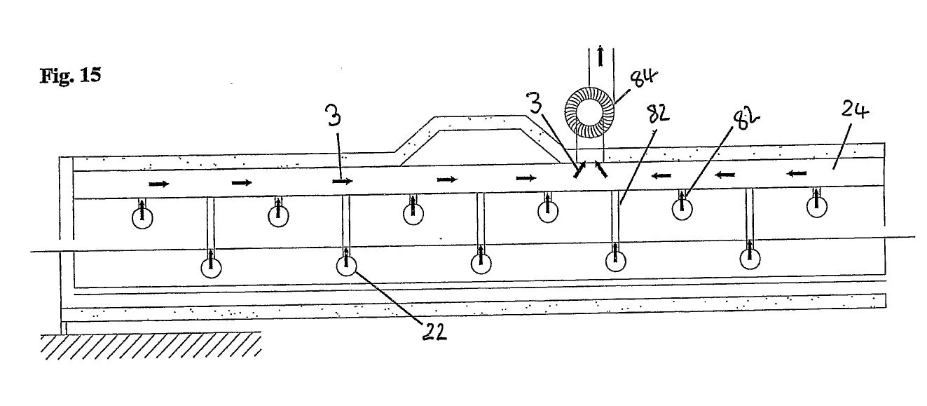

FIG. 15 is a schematic longitudinal sectional view through a zone to show the removal of combustion gases from the radiator tubes;

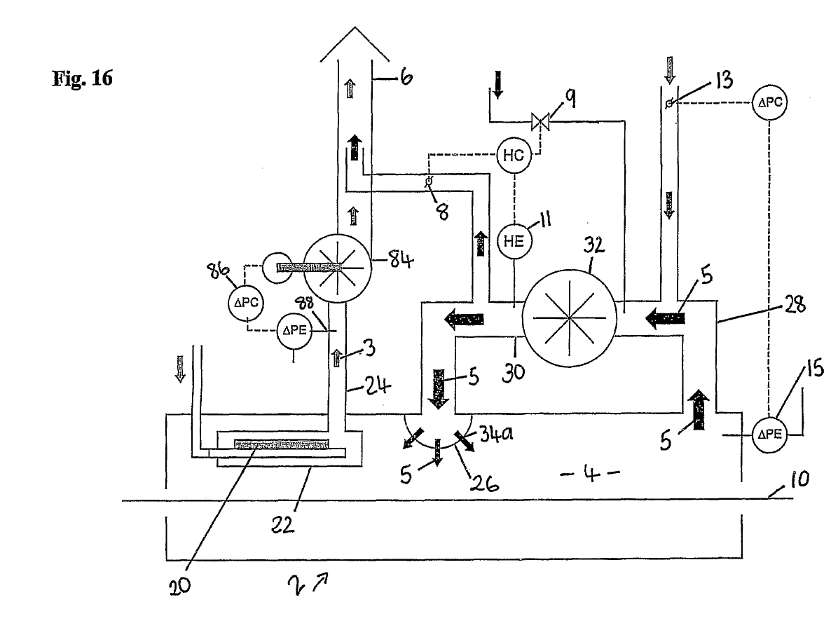

FIG. 16 is a highly schematic view of the oven showing air supply and return paths and exhaust of the oven;

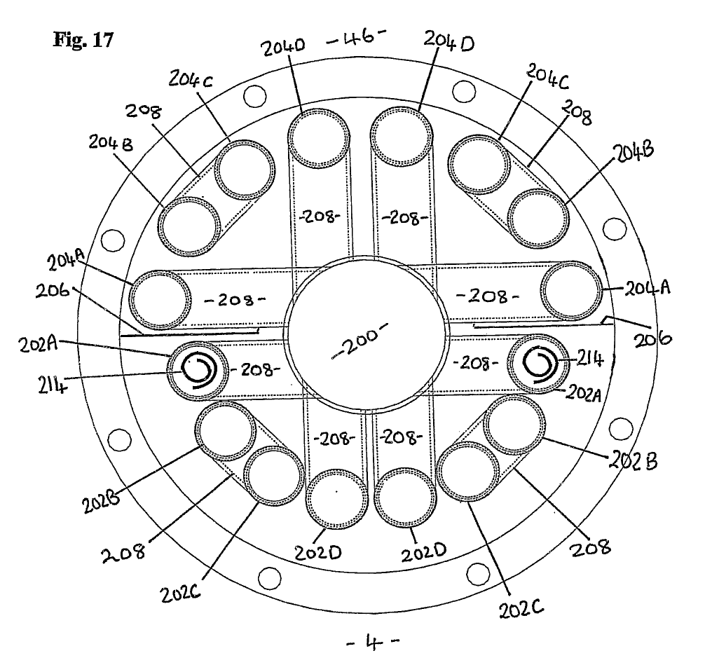

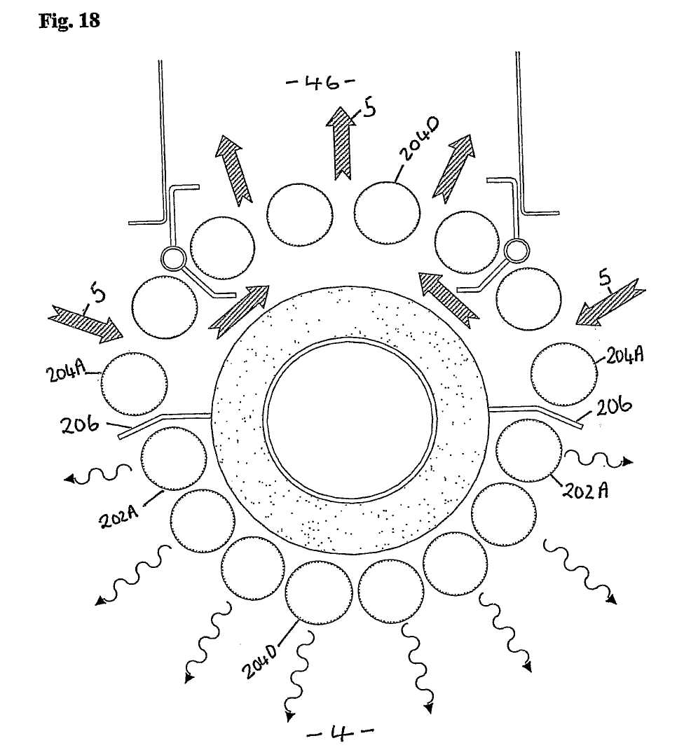

FIG. 17 is a cross-sectional view of a radiator constructed in accordance with a second embodiment of the invention;

FIG. 18 is a view similar to that of FIG. 17 illustrating the radiator in a mixed convention/radiation mode;

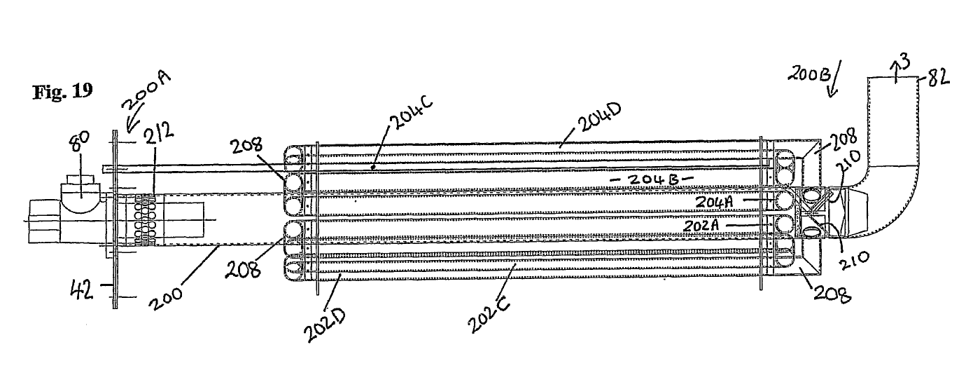

FIG. 19 is a longitudinal section view of the radiator of FIG. 17; and

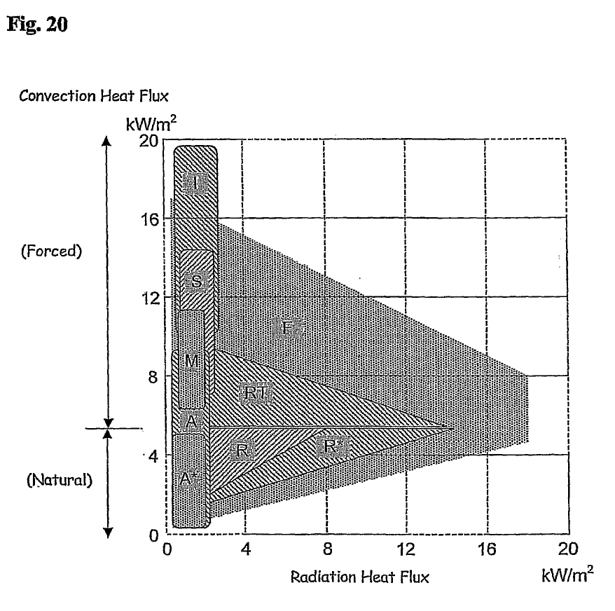

FIG. 20 is a graph comparing the adjustment capabilities of various know ovens for heat transfer to top surface of baked foods to that of an oven constructed in accordance with the present invention.

As best illustrated in FIGS. 1 and 16 a tunnel oven 2 constructed in accordance with one embodiment of the invention is in the form of a tunnel whose inner cavity forms a baking chamber 4. The baking chamber 4 is split into two zones 2a, 2b each having respective, exhaust stacks 6 and exhaust dampers 8 to set the exhaust flow in each zone 2a, 2b. A conveyor belt 10 mounted about two end drums 12 presents a support surface which runs through the baking chamber 4 and which returns through a band return channel 14 provided underneath the oven 2. In use food items to be baked are placed on the conveyor belt 10 at the entrance 16 to the baking chamber 4 and are conveyed through the baking chamber 4 to the baking chambers exit 18 and removed before the belt 4 makes its return journey to the ovens entrance 16 via the band return channel 14.

Each zone 2a, 2b comprises a plurality of burners 20 with a radiator tube 22a, 22b which has an exhaust 24 to vent the combustion gases 3 to the respective exhaust stack 6. The radiator tube 22a, 22b encloses the flames and prevents the combustion gases 3 entering the baking chamber 4, the radiator tube 22a, 22b is adapted to selectively emit radiant energy towards the conveyer belt 10. Between consecutive radiator tubes 22a is provided respective plenum chamber 26 to provide forced-air convection into the baking chamber 4.

An air return duct work 28 is provided to remove air 5 from the baking chamber 4 and an air supply duct work 30 is provided to supply that air to the plenum chambers 26. A fan 32 is provided between the two ductworks 28, 30 to re-circulate the air. The burner 20 within the radiator tube 22a is switchable between heating the radiator tube 22a to provide radiant heat to the baking chamber 4, and heating the radiator tube 22a to heat the air moving towards the return duct work 28 to supply the plenum chamber 26 with heated air for supply of heat by forced-air convection.

The forced-air convection that impacts on the food through nozzles 34a can be shut down whilst maintaining a constant back pressure within the supply ductwork/plenum chamber 30, 26, in that the plenum chamber 26 has a plurality of outlet nozzles 34 some of which feed into return ductwork 28 and others into the baking chamber 4. As best illustrated in FIG. 13 baffles 36 are provided inside the plenum chamber 26 which are movable to open and close the outlet nozzles 34. When the oven 2 is in full radiation mode the baffles 36 close the nozzles 34 leading into the baking chamber 4 and opens those leading to the return ductwork 28; by enabling the number of nozzles 34 to be open to remain constant the back pressure can be maintained.

A plurality of the radiators 22a, 22b are provided inside the oven chamber 4. A first series of the radiators 22a the upper radiators, are provided spaced apart along the length of the oven 2 above the conveyor belt and are designed to deliver radiation energy directly down onto the surface of the food as it is conveyed through the oven 2 on the conveyor 10. A second series of the radiators 22b, the lower radiators, are provided spaced apart along the length of the oven 2 below the conveyor belt 10 and are designed to deliver radiation energy directly up onto the lower surface of the conveyor belt 10; thereby delivering heat to the lower surfaces of the food via conduction through the belt 10 and, if provided through metallic containers containing the food. There may be no plenum chambers 26 provided between the lower radiators 22b, in order to facilitate cleaning of the baking chamber.

Each radiator 22a, 22b is in the form of an elongate tube which is closed at one end 38 and which extends transversely across the full width of the conveyor belt 10. Each radiator tube 22a, 22b is inserted closed end 38 first into the oven chamber 4 and mounted therein via a respective bore 40 provided in a control side wall 2c of the oven 2. The bore 40 and the open end of the radiator tube 22a, 22b is sealed by a removable face plate 42. The radiator tube 22a, 22b is fabricated from an alloy capable of withstanding operating temperatures up to 1000° C., one such suitable material is Inconel™.

Each radiator 22a, 22b is provided with a reflector 44a, 44b in the form of a pair of wings which extend along the length of the tube 22a, 22b and from opposing sides of the radiator tube 22a, 22b towards the conveyor belt 10 in a substantially v-shaped configuration. The reflectors 44a act to distribute the radiation energy towards the conveyor belt 10, so that a constant radiation heat flux is experienced by food items moving along the conveyor, before, directly underneath, and after each radiator tube, without creating locally excessive heat transfer fluxes directly under the burners. The lower reflectors 44b of the lower radiator tubes 22b distribute radiant heat upwards towards the conveyor belt's lower surface.

The reflectors 44b of the lower radiators 22b are removable in order to enable cleaning of the lower reflector tubes 22b, thereby enabling removal of food debris which has fallen through the conveyor belt.

The upper radiators 22a located over the conveyor belt 10 can be switched between radiation and convection mode. To this end the reflectors 44a of the upper radiators 22a as best illustrated in FIGS. 11 and 12 are modified in that the wings 44a extend around the back of the radiator tube to form an air return channel 46 about the surface of the radiator tube 22a facing away from the baking chamber 4 and which air return channel 46 leads into an entry duct 48 of the air return duct 28.

As best illustrated in FIGS. 9 and 10 inside each radiator tube 22a, 22b is a burner assembly 20 which can be accessed from outside the oven 4 by opening the face plate 42, to enable maintenance and/or replacement of the burner assembly 20 or components thereof. The burner assembly 20 comprises an air/gas mixture conduit 50 in the form of a central air/gas mixture supply chamber 50 sandwiched between two intermediate chambers 57. Air/gas mixture is supplied in use to the intermediate chambers via bores 54 extending between the supply chamber 50 and each intermediate chamber 57. A removable metal strip (not shown) having along its length holes of varying diameter and pitch is provided as an insert in each of the intermediate chambers 52, for the purpose of adjusting the relative size of the flame along the length of the burner. Each intermediate chamber 52 has an outer ribbon aperture 56 which supports the flame. The flame is contained between two baffles 77 one at each end of the radiator tube, to prevent excess heating at the sides of the oven.

An ignition electrode 60 is located at the end of the burner assembly closest to the face plate 42 and adjacent to one of the ribbon outlet channels 56. A sensing electrode 62 may be located diametrically opposite the ignition electrode 60, adjacent to the ribbon outlet channel 56 of the other intermediate channel 52. The ignition electrode 60 and the sensing electrode 62 are accessible and adjustable from outside the faceplate 42 for spark and sensing gap. They can also be removed for replacement.

A pair of flame deflectors 64 are also provided inside the radiator tube 22a, 22b one each side of the burner assembly 20. Each deflector 64 has a substantially T-shaped configuration and is provided with a pivotal mounting 68 at its apex and is pivotally connected thereby to the interior surface 70 of the radiator tube 22a such that the leg 72 of the T points towards the ribbon outlet channel 56 of the intermediate chamber 52. The leg of the T 72 extends along the full length of the ribbon outlet channel 56. The arms 74 of the T each act as a stop to limit the range of motion of the leg 72 via their respective abutment with the interior 70 of the radiator tube 22a, such that the leg 72 of the deflection 64 is movable across the ribbon outlet channel 56 of the intermediate chamber 52 between a position (as best illustrated in FIG. 11) whereby it deflects the flames down to the lower surface 76 of the tube 22a, 22b facing into the baking chamber 4 and a position (as best illustrated in FIG. 12) whereby the flames are directed up to the upper surface 78 of the tube 22a adjacent the air return channel 46.

In use an air/gas mixture is supplied to the air/gas mixture supply chamber 50 from a venturi mixer 80 arrangement positioned at the face plate 42. The mixture passes through the bores 54 into the intermediate chambers 52. A flame is generated by a spark from the ignition electrode 60 and the flame propagates along the length of the ribbon outlet channel 56, across a bridging section (not illustrated) at the free end of the burner assembly 20, and back along the full length of the other side of the ribbon burner 56. The integrity of the flame is optionally confirmed by sensing its arrival back at the face plate 42 end of the burner assembly 20 by the sensing electrode 62, otherwise the ignition electrode is also used for flame detection.

The free end of the radiator 22a, 22b is provided with a discharge tube 82 for removing the combustion gases 3 generated within the radiator tube 22a, 22b. The discharge tubes 82 from each radiator tube 22a, 22b, feed into a combustion gas collection duct 24 (as best illustrated in FIGS. 15 and 16) for removal via the exhaust stack 6. The combustion gases are withdrawn via a variable speed exhaust fan 84, controlled by a static pressure sensor 86 at the exhaust fan 84 inlet 88. The set point for this control loop will be slightly negative, just sufficient to ensure that all of the radiator tubes 22a, 22b draw a little air in through the front face plate 42 of the radiator tubes. The combustion gases are venting without entering the baking chamber 4, by passing through a dedicated collection duct 82, 24 which as best illustrated in FIG. 14 pass by the air re-circulating duct 28 enabling some of the heat from the combustion gasses to pass into this duct and to thereby heat the re-circulating air. Fins (not illustrated) may be used to increase the heat transfer. The exhaust flow from the combustion process, as best illustrated in FIG. 16 is used to entrain the necessary exhaust flow from the baking chamber, with the combined flow vented through exhaust stack 6. Vent control damper 8 and a steam supply valve 9 are controlled by a humidity sensor II in the re-circulation duct 30. Since there are no products of combustion in the circulating gases in the duct 30, a standard zirconia cell humidity sensor can be used.

Air intake into the oven is controlled by an air intake damper 13 which is in turn controlled by a static pressure sensor 15 in the baking chamber 4.

As best illustrated if FIG. 13 between each pair of adjacent upper radiator tubes 22a is a respective one of the plenum chambers 26, each having a semi-cylindrical profile which faces into the baking chamber 4 and whose longitudinal axis extends parallel to that of the radiator tubes 22a, 22b. Each plenum 26 is continually supplied with air via the air supply duct work 30. Each plenum chamber 26 has multiple outlet air nozzles 34 about its curved surface and contains two interior baffles 36 which are used to close selective outlet nozzles 34. Each baffle 36 has a substantially triangular configuration such that the baffles 36 form two spaced segments within the semi-cylindrical plenums 26 interior. The base 90 of each baffle 36 forms a slidable seal on the interior surface 92 of the plenum chamber 26, whilst their apexes 94 remote from the base 90 are mounted to a shaft 96 which is rotatable to reciprocally sweep the spaced baffle plates 36 across the interior surface 92 of the plenum 26 to selectively close and open the outlet air nozzles 34.

Each upper reflector 44a on a respective upper radiator tube 22a as mentioned above has a generally downwardly facing v-shaped configuration, additionally the free ends 98 of the wings 44a of the reflector contact a respective adjacent exterior surface of the plenums chamber, such that they split the outlet nozzles 34 of the plenum into two groups, a first of which 34a are dedicated to output air into the baking chamber 4 whilst the remainder 34b are dedicated to feed directly into air chambers 100 provided either side of the plenum chamber 26, which air channel is formed between the plenum chamber 26, the wings 44a of the reflector and the duct work of the air supply 30. The air chamber 100 is provided with an outlet 102 which feeds into the air return channel 46 about the surface of the radiator tube 22a which in turn leads into the air return duct 28.

The baffles 36 are individually selectively rotatable about the interior surface 92 of the plenum 26 to open and close the nozzles 34a, 34b which lead into the baking chamber 4 and into the air return channel 46. To explain by way of example with reference to the cross-section in FIG. 13 which illustrates 16 evenly spaced nozzles 34a, 34b about the periphery of the plenum. A first four 34b of which lead into air return channel 46 at one side of the plenum 26, the next eight 34a of which lead into the baking chamber 4, whilst the final four 34b lead into the air return channel 46 at the opposite side of the plenum 26. Each baffle closes four nozzles and they are rotatable between a first position whereby they come together and close all eight nozzles 35a leading into the baking chamber 4 and a position where they close the nozzles 34b leading to the air return ducts 46 either side of the plenum 26 thereby enabling all nozzles 34a leading into the baking chamber to be open. By this means always eight nozzles are open and eight nozzles closed as the baffles 36 slide between these two end positions, thereby maintaining a constant static pressure in the plenum 26. It should be understood that although 16 nozzles have been described in this example, a much larger number of nozzles are provided in that such are additionally equally distributed along the length of the plenum chamber 26.

The air re-circulation fan 32 in the air return 28 and supply 30 ductworks operates at a (selectable) fixed speed and the heat transferred by convection is adjusted by selecting which nozzles 34a, 34b are in use. However, the fan 32 has means to adjust its speed, for example in the instance that very light weight items are being conveyed on the conveyor belt 10.

The operation of the oven is as follows. As best illustrated in FIGS. 2 to 4 and 11 when the oven is in full radiation mode the deflectors are adjusted as illustrated in FIG. 11 to deflect the flame down to the lower surface 76 of the radiator tube 22a thereby heating the tube 22a to provide emitted radiant heat down to the upper surface of the food on the convey belt 4. The nozzles 34a of the plenum chamber 26 leading into the baking chamber 4 are closed by the baffles 36 and the air supplied to the plenum 26 from the air supply duct work 30 is output into the air chambers 100 wherefrom it is re-circulated by being drawn via fan 32 into the return air channel 46 about the back of the radiator tube 22a to the air return ducts 28. In this condition of operation no heat is provided by forced-air convection.

In full convection mode as best illustrated if FIGS. 5 to 8 and 12, the deflectors 71 in the radiator tube 22a are adjusted such that the flame is directed to the back 78 of the radiator tube 22a. The baffles 36 in the plenum chamber 26 are moved to open the nozzles 34a which lead into the baking chamber 4 and close those 34b which lead into the air chambers 100, The air re-circulation fan 32 draws air out of the baking chamber 4 around the back of the radiator tube 22a via air return channel 46 and is heated by the tube 22a as it passes there through to the return ducts 28 and is then supplied to the plenum chamber 26 via the air supply ducts 30 as heated air and forced through the nozzles 34a into the baking chamber 4. In this condition of operation minimal heat is received by the food by radiation from the radiator tubes.

It is to be understood that although the two extreme ends of the operation of the oven have been described above, that is the balance of forced-air convection being 0% or 100% of its maximum. The oven is adjustable by the selective opening and closing of the nozzle 34a leading into the oven chamber 4 to provide a required level of forced convection heat transfer during the radiation mode of the oven to achieve an optional combination of these two heat modes to best bake particular food items. Furthermore, the nozzles 34a that impinge on the food have been described as being around the perimeter of a cylindrical plenum chamber profile. This means that the resultant jets do not all travel the same distance before they impact the food. In a preferred embodiment the size of the apertures in each row is specifically selected to compensate for these distances, to arrive at a uniform convection heat flux along the length of the oven, and to create a significant forced convection heat transfer in the regions directly beneath the radiator tubes, where no nozzles are present. This will maximise the effectiveness of the convection heat transfer along the length of the baking chamber. The same effect may be achieved by altering the distribution and/or apertures of the nozzles. Also, the radiator tube has been described as containing two ribbon burners each having respective deflector 64 for deflecting the flames, but in one embodiment the deflectors may be operated independently such that the flames from one ribbon is directed to the lower surface 76 of the tube 22a whilst the flame from the other ribbon is directed to the upper surface 75 of the tube hence, redirecting some of the radiant heat to heat the air for the forced-air convection. Although two ribbon burners have been described there may only be one, or more such ribbon burners could be provided.

It is to be understood that whilst a two zone oven as been illustrated. The oven could contain any number of zones including a single zone, or have for example between 3 and 10 zones. Although a fixed number of radiators tubes and plenums have been illustrated these too could be varied in number.

Whilst the equalizing of the back pressure in the plenum has been described as the opening and closing of equal numbers of evenly distributed equal nozzles, the same effect can be achieved by providing a different distribution of unequal nozzles and/or a different configuration to the surface of the plenum which can be opened and closed in a manner which maintains a constant pressure within the plenum.

Although the lower radiators have been described as being able to supply radiant heat only, the plenum chambers could alternatively be provided below the belt to supply instead forced-air convection. Or a combination of plenum chamber and radiator tubes could be provided to facilitate a desired mixture of radiant and forced-air convection heat to the underside of the conveyor belt.

Although a pair of baffles has been described, a different number of baffles could be employed, or an alternative means of opening and closing the outlet nozzles on the plenum could be provided, for example mechanically or electrically operable control values.

Although the reflectors have been illustrated as having planar surfaces with a v-shaped profile, other shapes and configurations could be envisaged which provide a reflection and uniform distribution of the radiant heat across and along the length of the conveyor belt. Although the reflectors have been described with the presently described oven, such reflectors could be employed in other oven configurations for example one containing a radiant heat source only, either direct fired or indirect fired.

FIGS. 17 to 19 illustrate a modification to the radiator tube 22 in which the longitudinal ribbon burner is replaced by a central combustion tube 200 which leads to several series of tubes 202,204. In the illustrated embodiment, as best shown in FIGS. 18 and 19, there are sixteen such tubes 202,204 (although it is to be understood that a different number of such tubes could be provided). Each tube 202,204 extends along a respective axis which is parallel to the central longitudinal axis of the central combustion tube and are provided about the periphery of the combustion tube 200 in a spaced apart manner. A first eight of the tubes 202 face into the baking chamber 4 of the oven and are adapted to provide radiant heat into the oven, whilst the remaining eight tubes 204 face the air return channel 46 and are adapted to heat the recirculating air in order to provide the convection mode for the oven. The radiation mode tubes 202 and the convention mode tubes 204 are separated by an internal plate 206 which extends either side of the combustion tube 200 to provide an air seal between the radiation mode tubes 202 and the convection mode tubes 204.

The central combustion tube 200 is provided with an inlet end 200A and outlet end 200B. The outlet end 200B leads into the radiation mode tubes 202 and the convection mode tubes 204 as follows:

Outlet end 200B of central combustion tube 200 connects to two of the radiation mode tubes 202A (as best illustrated in FIG. 17) by a respective inlet elbow 208, these tubes 202A, being located diametrically opposite each other and being the tubes, furthest away from the baking chamber 4 and closest to the convection mode tubes 204. The opposite end of tubes 202A connect into respective adjacent tube 202B via a respective elbow 208 located adjacent the inlet end 200A to the combustion tube 200. The radiation mode tubes 202B lead back to the outlet end 200B where they connect to respect adjacent radiation mode tubes 202C by respective elbows 208. Likewise the opposite end of radiation mode tubes 202C connect to radiation mode tubes 202D via a respective elbow 208 which tube leads back to the outlet end 200B of the central combustion tube 200B. At the outlet end of radiation mode tubes 202D a respective elbow 208 connects each tube 202D into the collection duct 82 for venting, as per the previous embodiment.

In a similar manner the outlet 200B of the central combustion tube 200 leads into the convection mode tubes 204 with two convention mode tubes 204A leading into respective convection mode tubes 204B, then 204C and 204D connected via respective elbows 208 and the final convention mode tubes 204D leading into the collection duct 82.

A diverter valve 210 is provided at the outlet to the radiation mode tubes 202D and convection mode tubes 204D to provide a baffle described further hereinafter.

As in the previous embodiment an air/gas mixture is supplied to an air/gas mixture supply chamber 50 from a venturi mixer arrangement 80 positioned at the face plate 42. The mixture passes into a burner assembly 212 located inside the central combustion tube 200 adjacent its inlet end 200A. In use an elongate flame is produced by the burner assembly 212 which extends down the central combustion tube 200. The resultant hot gases flow out through the tubes 202,204 heating the series of tubes.

To provide radiation only mode the diverter valve 210 is actuated to close the outlet of convection mode tubes 204D and the hot gases are vented through the radiation mode tubes 202. To provide convection mode only the diverter valve 210 is actuated to close the outlet of radiation mode tube 202D to block the flow of hot gases through the radiation mode tubes 202A, 202B, 202C and 202D, and to direct the hot gases solely through the convention mode tubes. To provide a mixture of convection and radiation heating modes the diverter valve is adjusted to provide a required amount of heat through the convection and radiation mode tubes 204,202 respectively to achieve the required balance between the desired amount of convective heat and radiation heat for the item of be baked.

As in the previous embodiment various sensors can be provided to enable adjustment of the heat in each mode. Also the various radiation and convection mode tubes 202,204 can be provided with spiral inserts 214 which can be tuned to adjust the amount a heat emitted by a particular tube.

The hot gases initially enter radiation mode tubes 202A, which are located further from the conveyor 10 than the other radiation mode tubes 202B, 202C and 202D. Due to the annular arrangement of the radiation mode tubes 202 about the combustion tube 200 as the hot gases pass into the next tube 202B, then 202C and finally 202D, the tubes get progressively closer to the conveyor 10. This has the advantage of providing a more even heat along the length of the oven. This is because the hot gas progressively cools at it passes through the tubes and the radiation mode tube 202A furthest from the baking chamber 4 will therefore be hotter than each of the subsequent tubes, which as each gets progressively cooler they get closer to the baking chamber. Fine tuning to each tube as mentioned above can be made via the spiral insert, to further smooth the radiant heat profile along the length of the oven.

As in the previous embodiment the various components could be removable for easy replacement via the face plate 42.

Whilst the diverter valve has been described as being located at the outlet to the tubes 202, 204, the valve could be located elsewhere in order to adjust or prevent the flow through the respective tubes.

Whist spiral inserts have been described, these could be replaced by emissivity coatings, or be in addition to emissivity coatings to the radiator tubes.

The convection mode radiator tubes as best illustrated in FIG. 18 are spaced further from the central combustion tube 200 to provide a greater heat exchange with the recirculating air.

Referring to FIG. 20 which is a chart comparing convection heat flux (kW/M²) both natural and forced to radiation heat flux (kW/M²) for a variety of oven types and showing their capability to transfer heat to the top surface of baked foods. The data was measured using a scorpion oven data logger. The results for each oven type are illustrated as follows:

### Direct Fired Ovens

2-40% vol humidity
I=Impingement re-circulation oven
A=Re-circulation oven (‘direct’ mode)
S=Re-circulation oven
R=Ribbon burner oven
R*=with radiant burner
RT=Radiant tube oven

### Indirect Fired Ovens

2-98% vol humidity
A*=Re-circulation oven (‘indirect’ mode)
M=Re-circulation oven
F=New oven constructed in accordance with the invention

As can be seen from the results of the tests shown in the chart the present oven can replicate the baking condition present in many existing ovens and can therefore find use as a sole replacement for many different types of oven, reducing costs and space requirements. Furthermore, the present oven is able to produce baking conditions via its combustion of radiant and convection heating modes enabling it to bake new and/or innovative foods in previously unexplored combinations of radiation, convection and humidity.

It is of course to be understood that the invention is not intended to be restricted to the details of the details of the above described embodiments which are described by way of example only.

1-44. (canceled)

45. A tunnel oven having a baking chamber and a conveyor for carrying items to be baked through the baking chamber, an in-direct fired radiant heat source operable to supply radiant heat into the baking chamber for baking items conveyed, a forced-air convection heat source operable to selectively supply heat by forced-air convection into the baking chamber for baking items conveyed, an air-recirculation system which has means to draw air from the oven chamber and means to supply that air to the forced-air convection heat source, and adjustment means to change independently the atmospheric moisture content in the baking chamber and the quantities of radiant heat and convective heat, wherein the adjustment means comprises means to maintain a substantially constant pressure in the air recirculation system, the convection heat being adjustable between 0% and 100% of maximum available forced-air supply into the baking chamber.

46. A tunnel oven as claimed in claim 45, wherein the oven has a convection heat transfer to top surface of food in the range 10-140 W/m²° C.

47. A tunnel oven as claimed in claim 45, wherein radiation heat transfer is in range Tr=150-700° C., where Tr is the hemispherically averaged perceived radiation temperature, as experienced by the upper surfaces of food items traveling on the conveyor, and wherein humidity levels in the baking chamber are adjustable between 2% and 98% by volume water vapour.

48. A tunnel oven as claimed in claim 45, wherein the adjustment means is adapted to adjust the distribution of radiant heat supplied along the length of conveyor to provide a substantially even heat profile along the length of the conveyor.

49. A tunnel oven as claimed in claim 45, wherein the adjustment means comprises means to selectively adjust the supply of forced-air into the baking chamber by redirecting that air back into the air-recirculation system.

50. A tunnel oven as claimed in claim 45, wherein the forced-air convection heat source comprises at least one plenum which supplies air to a plurality of air outlets which lead into the baking chamber, the adjustment means having a maintaining means, and wherein the plenum has a plurality of further air outlets which lead into the air-recirculation system, the maintaining means being adapted to switch the supply of forced-air between the air outlets and further air outlets in a balanced manner to maintain a substantially constant static pressure in the plenum.

51. A tunnel oven as claimed in claim 50, wherein the further air outlets are conductively connected to the radiant heat source and open into oven air outlets provided in the baking chamber which lead into the air recirculation system.

52. A tunnel oven as claimed in claim 50, wherein the air outlets have at least one of a defined distribution or apertures sizes to provide a uniform convection heat flux along the length of the oven.

53. A tunnel oven as claimed in claims 50, wherein the maintaining means comprises at least one baffle moveable across the air outlets and further air outlets.

54. A tunnel oven as claimed in claim 50, wherein the maintaining means comprises two baffles moveable across the air outlets and further air outlets.

55. A tunnel oven as claimed in claim 45, wherein the radiant heat source comprises a main combustion tube leading into a series of successive radiation mode tubes and a series of successive convection mode tubes providing said convective heat source, the burner assembly being located at an entrance to the main combustion tube and being adapted to provide a flame along the main combustion tube to produce hot gas, the adjustment means comprising a deflector which is selectively moveable to direct said hot gas into said radiation mode tubes and/or said convention mode tubes.

56. A tunnel oven as claimed in claim 55, wherein the radiation mode tubes and/or convection mode tubes comprises tuneable inserts and/or emissivity coatings.

57. A tunnel oven as claimed in claim 55, wherein the radiation mode tubes are annularly located around the side of the main combustion tube facing the conveyor, the main combustion tube initially leading into two oppositely disposed radiation mode tubes leading into a respectively succession of said tubes located progressively closer to said baking chamber.
